(19) United States
(12) Patent Application Publication
(10) Pub. No.: US 2005/0042323 A1
(43) Pub. Date: Feb. 24, 2005

(54) Method and device for the automated handling of resin-impregnated mats during the production of smc parts

(76) Inventors: Uwe Habisreitinger, Lossburg (DE); Bernhard Nordmann, Boblingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/493,096

(22) PCT Filed: Sep. 3, 2002
(86) PCT No.: PCT/EP02/09831

(30) Foreign Application Priority Data
Oct. 20, 2001 (DE) 101 52 232.0

(51) Int. Cl. A21C 1/00

(52) U.S. Cl. 425/472

(57) ABSTRACT

A method and a device for the automated handling of resin-impregnated mats of differing shape and size during the production of SMC components, utilizes a suction gripper which can be manipulated multiaxially. A plurality of suction bells are distributed in a grid pattern on the suction gripper, each suction bell being actuable individually by a vacuum. The rigid suction bells, which are mounted via a flexible element, have a cup-shaped cross section with an edge that tapers to a point, and can be placed onto and form a seal with the resin-impregnated mats. Rotating brushes are provided for cleaning the suction bells. The suction gripper is combined with pivotable fixing spikes for securing the stack of mats at the uppermost layer of the stack. The suction bells can be raised and lowered to different levels via lifting cylinders and can be fixed in any desired intermediate positions by means of brakes.

### BACKGROUND AND SUMMARY OF THE INVENTION

The invention relates to a method and a apparatus for automatically handling resin-impregnated mats during the production of SMC components.

According to an article by R. Brüssel and U. Weber “SMC-Teile vollautomatisch herstellen” [Fully automatic production of SMC components], published in the journal Kunststoffe, year 79 (1989), pages 1149-1154—(hereinafter Brüssel et al.), the production of SMC components starts with a specific amount of a mixture of reactive thermosetting synthetic resin and fibers that is adapted in its weight to be appropriate for the finished component. To be precise, the adapted amount of raw material is obtained by cutting out rectangular blanks of a specific size from a fiber mat web (prepreg web) supplied in roll form and by laying the blanks together to form a stack of mats. Such a stack of mats is placed exactly in position into an opened mold of a press that is heated to a temperature at which the reactive synthetic resin chemically reacts and sets.

By closing the mold slowly at first, the raw material introduced is initially merely heated, as a result of which the synthetic resin becomes even softer and more free-flowing. Subsequently, the mold is closed with a controlled force and speed, so that the softened raw material flows away to the sides and thereby completely fills the cavity of the mold. After this filling of the impression, the mold is kept closed for a time with a defined force, so that the synthetic resin can fully react and cure. Only then can the mold be opened and the finished SMC component removed from it.

In the method according to Brüssel et al., the blanks arranged in layers to form a stack of mats as a raw mass are all rectangularly shaped and all have the same width in one direction, lying transversely to the web of resin-impregnated mats (that is the width of the web of resin-impregnated mats itself trimmed at the edges). The blanks are produced by cutting across the web of resin-impregnated mats, with the cut blanks being deposited on a moveable platform which is arranged in the direct vicinity of the cross-cutting device and is designed in the form of a rake—a stacking rake. As soon as the blanks arranged in layers on the stacking rake have reached the desired number of layers, the stack of resin-impregnated mats is transferred by the moveable stacking rake onto a transfer rake of similar construction arranged in the vicinity of the press. Specifically, the stack of resin-impregnated mats is deposited on the transfer rake by vertical lowering of the stacking rake onto the transfer rake with supporting prongs arranged in a mutually staggered manner.

Integrated in said transfer rake is a retaining rake, the prongs of which are vertically oriented and with respect to which the transfer rake is guided in a horizontally moveable manner and is provided with a corresponding displacement drive. In order to deposit the stack of resin-impregnated mats in the lower mold of the press, the transfer rake with the stack of resin-impregnated mats situated on it is positioned above the impression of the lower mold with (under certain circumstances) the prongs of the transfer rake at a slight inclination. In response to a certain control command, the transfer rake can be pulled back horizontally with respect to the retaining rake or in the direction of the supporting prongs, in which case the stack of resin-impregnated mats lying on it will be transferred into the opened mold and deposited more or less exactly in position therein.

German patent document DE 39 15 380 A1 shows a very similar transfer rake. One disadvantage of the method according to Brüssel et al. is that all of the blanks are rectangular and, in principle, are identical in size, but this can only be readily allowed for a restricted range of components.

A further disadvantage of the arrangement according to Brüssel et al. or the transfer rake according to DE '380 resides in the handling device itself which does not allow a direct weighing of the blanks. In addition—apart from simple stacking—other processes for handling individual mat blanks using the known handling rake would only be possible if the individual blank rests on an interrupted base shaped specifically for the rake, which is not generally the case. The positioning accuracy when handling individual mat blanks or an entire stack of resin-impregnated mats suffers, however, because the item to be handled executes an uncontrolled self-movement during the transfer due to the force of gravity and friction. Since the supporting prongs of the transfer rake define a level depositing surface, but the impression of the lower mold is uneven, the transfer rake has to maintain a certain minimum distance in the vertical direction from the impression during the transfer of the resin-impregnated mats.

Moreover, the resin-impregnated mats are transferred onto the impression in a progressive manner—starting from one side of a mat—on account of the withdrawal movement of the transfer rake with respect to the retaining rake, in which case the resin-impregnated mats move past the transfer point and are locally deformed in an S-shaped manner. The position ultimately adopted by the resin-impregnated mat on the impression is determined by the initial, first setting down on the impression of the first edge of the mat to be transferred.

Depending on the limpness of the resin-impregnated mat, its initial set-down point (quite apart from the dispersive vertical and/or horizontal relative position between the transfer rake and impression at the beginning of the transfer) may be situated to a greater or lesser extent forward or rearward with respect to the withdrawal direction of the transfer rake. In this case, two different phenomena, both associated with the extent of the softness of the resin-impregnated mats, substantially influence this dispersion of the initial set-down point.

First, a soft resin-impregnated mat hangs more steeply down the free ends of the supporting prongs than a stiff resin-impregnated mat because of the force of gravity, so that a soft resin-impregnated mat will be set down farther to the rear than a stiff resin-impregnated mat. Secondly, because of friction, a soft and/or more sticky resin-impregnated mat will stick more strongly onto the supporting prongs of the transfer rake in the withdrawal direction than a stiff and/or less sticky resin-impregnated mat. Accordingly, for this reason too, a soft resin-impregnated mat will be set down farther to the rear than the stiff resin-impregnated mat.

The dispersive influences of the condition of softness of the resin-impregnated mats which are caused by the force of gravity and by friction, therefore accumulate in the same direction. It is virtually impossible to detect these influences and compensate for them by differently positioning the initial position of the transfer rake. When operating with the transfer rake known from Brüssel et al. or DE '380, a considerable dispersion of the transfer position of the resin-impregnated mats in the impression of the lower mold therefore has to be taken into account, which has a direct effect on the workpiece quality of the molding which is produced. In the direction of the lateral offset of the actual position with respect to the desired position, the press-formed workpiece has a tendency to be too thick and, in the opposite direction, it is on the contrary too thin.

German patent document DE 40 29 910 A1 shows a press for the production of SMC components, in which an exchangeable auxiliary device is provided in each case lying opposite each other on both sides, both level with the lower mold and also level with the raised upper mold. Due, to a useful rail arrangement it is possible to insert one of the auxiliary devices in each case into the press in the opened state of the latter, so as to directly face the impression of the lower mold or upper mold. It is possible to insert auxiliary devices into the press successively in an alternating manner. The moveable auxiliary devices, which are constructed in a framework-like manner, are adapted to the particular compression mold and, due to controllable implements which are fitted, are aimed at different tasks (for example inserting mats or inserts, removing the finished components or cleaning the mold).

One of the auxiliary devices is assigned to re-equip the lower mold (that is to insert the stack of resin-impregnated mats and inserts). However, this purpose and the design of the last-mentioned auxiliary device may be gathered from DE '910 only in very sketchy form. Just two units, which are spaced apart at the distance of the overall size of the finished component, are arranged in mirror symmetry to each other, and could be used for handling the stack of resin-impregnated mats, are graphically indicated and are not mentioned in the description. However, it remains open as to whether needle grippers, pincer grippers or other grippers are involved; furthermore, it is unclear whether, and if appropriate, how the grippers can be moved.

The insertion aid known from DE '910 merely makes it unnecessary for workers to work in the immediate surroundings of the hot mold, which would be ergonomically extremely unfavorable both due to the heat and due to the poor accessibility of the mold. In each case, the handling device presupposes that the stack of mats which is to be inserted has been laid out ready beforehand in a defined position at a certain pick-up point in the vicinity of the lower mold. However, for its part this is extremely problematic for automated manufacturing, and is not solved by the insertion aid. Even if a positionally accurate provision of the stack of resin-impregnated mats on a transfer table could be presumed, the resin-impregnated mats would sag to a greater or lesser extent, as a function of the varying softness of the resin-impregnated mats, because of the force of gravity, even if the resin-impregnated mats were grasped at the edges. The first set-down point of the resin-impregnated mats on the impression of the lower mold differs in position as a function of the amount by which they sag. However, the position of this first set-down point determines the subsequent end position of the entire stack of resin-impregnated mats because after the initial setting down of the resin-impregnated mats at points on the impression, a relative displacement of the resin-impregnated mats no longer takes place. When the sagging resin-impregnated mats are lowered onto the impression, the resin-impregnated mats roll along the surface of the mold, but otherwise remain stuck to the surface.

U.S. Pat. No. 4,576,560 is likewise concerned with the automated insertion of resin-impregnated mats into the opened mold of an SMC-component press. Specifically, it proposes a needle gripper having a plurality of needles which are arranged in a spatially inclined manner with respect to the direction of the force of gravity and can be telescopically extended when the resin-impregnated mats are being picked up and can be retracted again when they are being deposited. An axially displaceable scraper which can be displaced independently of the needle is connected to the gripper needles. The needles are arranged in a spatially inclined manner such that the angle between the needle and resin-impregnated mat is enlarged in the direction of a right angle when the resin-impregnated mat sags in the manner of a garland, but the needles themselves are secured immovably in their spatially inclined arrangement. The needle gripper works with a depositing and pick-up table which is roughly matched to the lower mold and has cut outs at the puncture points of the needles, so that the gripper needles can be inserted without any obstruction through the mats to be picked up.

Similarly as in DE '910, the handling device known from U.S. Pat. No. 4,576,560 also merely concerns a transfer device which presupposes that the stack of mats to be inserted has been laid out ready for it beforehand in a defined position at a certain pick-up point in the vicinity of the lower mold. To this extent, the same criticism as for DE '910 can also be applied for the '560 patent. Added to this is the fact that, in the case of the needle gripper according to the '560 patent, the puncture points of the needles, when the resin-impregnated mat is lifted up and transported, stretch to a greater or lesser extent, depending on the softness, which is dispersed locally or temporally, and/or the fiber content, because of the force of gravity. Also, the puncture holes of the retaining needles that have expanded to a greater or lesser extent therefore likewise bring about a different dispersed position of the sag of the resin-impregnated mat which is being picked up. In addition, the position of the puncture points is dispersed as a function of the hardness of the resin-impregnated mat to be picked up and/or as a function of the cleanliness of the needles. This dispersion of the position of the sag, which is brought about by the type of construction of the gripper, is combined with the dispersion of the magnitude of the sag which has already been described in conjunction with DE '910 and depends on the hardness.

European Patent document EP 461 365 B1 discloses a method for producing plastic moldings from thermoplastic material, in which an amount of heated and softened thermoplastic material appropriately adapted in weight is placed into an opened mold of a press. The molding compound is forced to flow into the cavity of the mold by closing the mold, and subsequently the workpiece, still located in the mold, is cooled and finally removed from it. In order to remove the finished workpiece from the opened compression mold, use is made of a suction gripper which is handled by a triaxially moveable manipulator and has two suction cups per workpiece.

Although EP '365 does not discuss the configuration of the suction cups in greater detail, it can be stated that, in the case of suction grippers, use is made of conventionally adaptable suction cups made of soft elastic material and in which the edge of the suction cup is designed as a sealing lip of thin cross section which opens downwards in the manner of an umbrella and which can effectively nestle against unevennesses of the surface and can therefore provide a good seal. A disadvantage of suction grippers for handling reactive and sticky resin-impregnated mats in the manufacturing of SMC components however, is, that they have a tendency to become dirty and must therefore be rejected as being susceptible to faults, which is justifiably pointed out earlier by DE '380 in conjunction with the acknowledgement of the literature reference Brüssel et al.

Taking the prior art which has been described as the starting point, one object of the invention is to provide an improved method and apparatus for handling resin-impregnated mat blanks, with which blanks of any desired shape can be picked up from a flat, continuous base and with which all of the handling processes that customarily occur during the manufacturing of SMC components (both in respect of individual blanks and also in respect of stacks of mats) can be carried out in a manner free from faults and in automated fashion with high operating accuracy. In particular, any fluctuations in the hardness or softness of the resin-impregnated mats should not in any way affect the positional accuracy of the resin-impregnated mats when the same are being picked up or deposited.

This and other objects and advantages are achieved by the method and apparatus according to the invention, in which the resin-impregnated mats, which differ in shape and size under some circumstances, are handled in automated fashion by a suction gripper that can be manipulated in a multiaxial manner, and are secured on the top side simultaneously at a number of points. The numerous suction bells are provided in a grid on the lower side of the suction gripper in a suction bell plane and consist of an inflexible material. They can be activated, individually in each case, by a vacuum.

The item which is to be handled is in principle secured over the entire top-side surface in the level state and retains this level form while being picked up, transported and while being deposited, irrespective of how soft the resin-impregnated mats are. The suction bells have a cup-shaped cross section with an edge which tapers to a point and can sink into the surface of the mat in a sealing manner. Owing to the grid arrangement of the large number of individually activatable suction bells, the suction gripper can be adapted to different sizes and/or shapes of mat blanks by simple control measures. Owing to the inflexible cup shape, not only is a higher retaining force achieved in comparison with a flexible rubber suction cup of the same size, but also a higher vacuum can be applied without deforming the suction bell. Because the annular cutting edge of the bells sinks into the surface of the mat, provides a very good seal, and likewise makes possible a high vacuum and a high retaining force. In spite of a surface which is rippled and/or provided with superficial pores, additional air does not creep into the suction bells even in the evacuated state. Thus, the calculated retaining force arising from the level of the vacuum and clear cross-sectional area of the suction bell may, if appropriate, also become actually effective, in contrast with known suction cups which always suck in a certain amount of additional air when workpieces having an uneven surface are used, greatly reducing the effective retaining force in comparison with the value calculated as being possible.

On the one hand, the dimensionally stable suction bells are less susceptible to becoming dirty, on account of their narrow contact surface with the resin-impregnated mats, and, on the other hand, they are designed to be easy to clean because of the exposed position and stable shape of the contact surface. The suction bells can therefore be effectively cleaned again mechanically by means of cleaning brushes, which can be driven in a rotary manner and are arranged in the action region of the handling device, by the suction gripper bringing the edges of the suction bells into contact with the cleaning brushes.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic overall view of an installation for the method in a plan view;

FIG. 2 shows the cutting table with the outline on a web of resin-impregnated mats for the cutting to size of the parts of a seven-part stack of resin-impregnated mats;

FIG. 3 shows a device set up on a weigher for deforming and weighing the basic blank and for laying out ready a stack of resin-impregnated mats obtained according to FIG. 2;

FIG. 4 is a side view of a universally and flexibly usable suction gripper with a multiplicity of suction bells that can be moved by lifting;

FIGS. 5 and 6 show two details V and VI respectively, from FIG. 4 that are illustrated on an enlarged scale;

FIG. 7 is a view of the lower side of the suction gripper according to FIG. 4;

FIG. 8 shows the process of picking up an entire stack of resin-impregnated mats with the securing assistance of obliquely inserted fixing spikes;

FIG. 9 is a view of the process of cleaning the suction bells on an assemblage of rotationally driven, profiled cleaning brushes arranged in the form of a grid;

FIGS. 10a and 10b show two phases when picking up an individual resin-impregnated mat blank with the suction gripper from a flat base;

FIGS. 11a to 11d show four phases when depositing the resin-impregnated mat blank onto a stepped base without being engaged around by the suction gripper; and

FIGS. 12a to 12e—show five phases likewise when depositing the resin-impregnated mat blank onto a stepped base, but with the suction gripper first of all depositing the blank in an exact position only on the upper step and depositing it offset laterally on the lower step (FIG. 12c), then engaging around it and, with the assistance of a strip-shape insertion tool fitted to the suction gripper, also depositing the blank in an exact position on the lower step (FIGS. 12d and 12e).

### DETAILED DESCRIPTION OF THE DRAWINGS

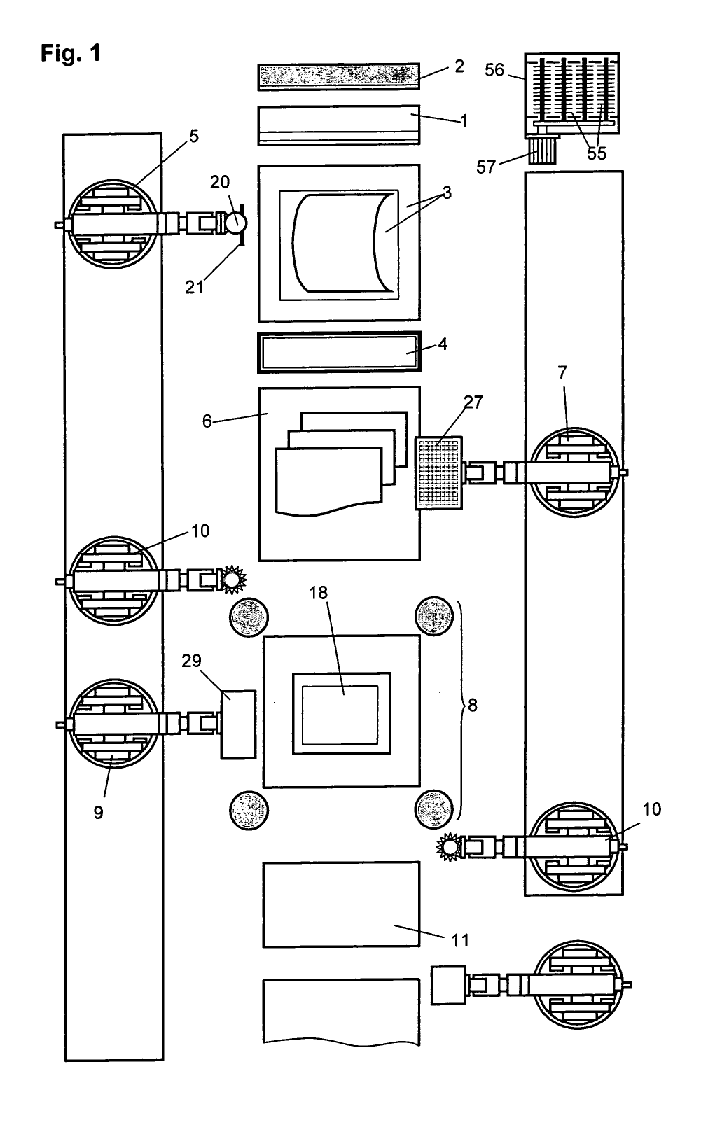

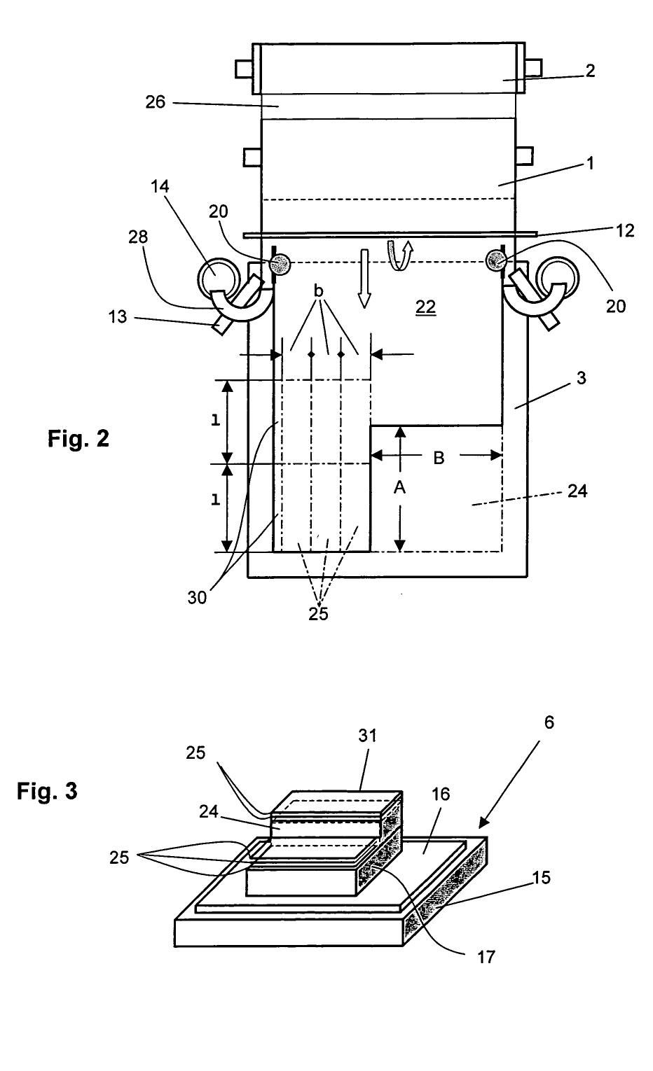

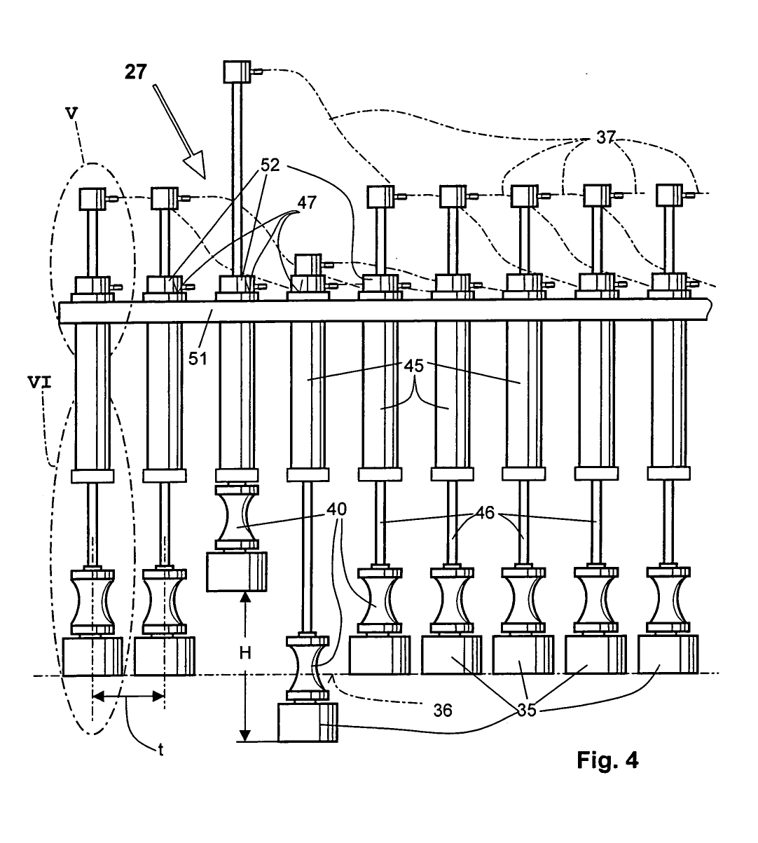

The method according to the invention which it proceeds for producing series of SMC is explained briefly on the basis of the diagram of the method according to FIGS. 1 and 2. The SMC components are produced from fibrous, reactive resin mass which is provided in the form of a virtually endless web 22 of resin-impregnated mats wound up into a supply roll 1 as the initial product. To maintain the reactivity of the synthetic resin in the web of resin-impregnated mats 22, the latter is covered with a protective film 26, which is pulled off and rolled up to form a separate roll 2 only shortly before the processing of the resin-impregnated mat. As can be seen more clearly in FIG. 2, the protective film is deflected counter to the processing direction of the resin-impregnated mat to the roll 2 via a reversing rod 12 located in the vicinity of the cutting table 3. The side edges of the web of resin-impregnated mats are unsuitable for further processing and must be cut off by a cutting tool 20. The lateral waste strips 28 cut off at the edge of the web are likewise deflected via reversing rods 13 into waste containers 14.

The usable part of the web of resin-impregnated mats 22 is cut up on the cutting table 3, which is provided with a very hard support. Various blanks of a defined shape and size are cut out from it and stacked up to form a multilayer stack of resin-impregnated mats of a specific number of layers and arrangement of layers. The trimmed-off parts, which cannot be used any further, are removed into a corresponding waste container 4. Cutting to size may, in principle, be performed manually with a sharp knife and steel rule. In the case of the exemplary embodiment illustrated in the figures, however, a mechanized and automated cutting to size by means of a cutting robot 5 is provided.

On a separate weighing and stack-forming device 6 (FIG. 3), the blanks cut by the robot 5 on the table 3 are stacked up to form a stack of resin-impregnated mats 31. The blanks are handled and moved by a handling robot 7, which, for its part, is equipped with a resin-impregnated mat gripper 27 that is designed specifically for this task and this substrate, as is discussed in greater detail below. Once the stack of resin-impregnated mats 31 has been formed in an appropriate shape for a new workpiece, it is placed by the handling robot in a defined position into a heated mold 18 of the molding press 8.

The mold 18 is closed by the press until the molding surface of the cavity is in contact with the inserted stack of resin-impregnated mats and is clamped in the closing direction by a defined, initially still small, force. The contact with the hot mold causes the resin mass to be heated, and softened as a result. On account of the closing force of the mold, the resin mass begins to flow, and finally completely fills the cavity of the progressively closing mold 18. The mold is subsequently held in the closed state with increased force for a certain time, the resin mass thermally curing. Once this curing time has elapsed, the press 8 opens the mold, with the finished SMC component as a rule remaining in the lower, fixed mold half. The SMC component can be removed from the press and deposited in a cooling station 11 by a removal robot 9, which is provided with a removal tool 29. While the cutting and handling robots 5 and 7 prepare a new stack of resin-impregnated mats, the opened mold 18 is cleaned by two cleaning robots 10, so that it is ready to receive a new stack of resin-impregnated mats.

In order to be able to cut blanks, which are shaped and/or arranged as desired and, in particular, differ in size, from the web of resin-impregnated mats 22 in automated fashion and in a manner free from faults, the recommended cutting tool is a high-frequency rotationally oscillating saw blade 21 driven by an electric tool 20 with an integrated oscillation mechanism, which executes small rotary strokes about a fixed central position. While the cutting takes place, the web of resin-impregnated mats 22 is supported by a smooth, continuous and also joint- and gap-free base in the form of a thick glass plate 23 which is harder than the cutting teeth of the saw blade.

One substantial problem in the production of series of SMC components resides in a rapid and accurate, but especially automatable handling of the resin-impregnated mat blanks. The intention is for blanks of any desired shape to be able to be picked up from a flat, continuous base and for all of the handling processes that conventionally occur during the manufacturing of the SMC components both in respect of individual blanks and also in respect of stacks of mats to be able to be carried out in a manner free from faults and in automated fashion with high operating accuracy.

In this context, it should be remembered that, in order to achieve the previously described desired weight of the resin mass to be inserted into the mold, at least some blanks of different surface area have to be cut out of the web of resin-impregnated mats 22, which has a fluctuating basis weight. The handling of the blanks 25, which are cut to size with a variable surface area and are positioned in a locally differing manner on the cutting table 3, may cause further handling problems during the assembling of the stack of resin-impregnated mats.

In the exemplary embodiment illustrated in FIG. 2, a stack of resin-impregnated mats is formed from a total of seven blanks, including a particularly large base blank 24 and six other, substantially smaller blanks 25, which are stacked up on the (lowermost) base blank 24, in two small stacks situated next to each other. The base blank is always cut to size to the same surface area with the constant side dimensions of A×B, and is then weighed and from the measured weight a conclusion is drawn as to the basis weight of the web of resin-impregnated mats. On the assumption that the basis weight is virtually unchanged in the direct vicinity of the base blank, the remaining blanks 25 are cut to size with a variable surface area but specifically in respect of a constant total weight, in accordance with a specific algorithm. Specifically, in the example illustrated, the length 1 of the remaining blanks 25 is kept constant for all of the workpieces but the width b is varied individually to adapt the weight; in this case, the width in the example illustrated is identical for all six blanks 25 of a stack of resin-impregnated mats. A trimmed-off strip 30 which differs in width, in each case depending on the local basis weight of the web of resin-impregnated mats 22, is produced on the left-hand side edge.

Added to this is the fact that the space requirement, which can be seen in FIG. 2, for the seven blanks 24 and 25 shown there cannot be distributed uniformly over the width of the web of resin-impregnated mats 22. In the region of the base blank 24, only a material of size A is used in the longitudinal direction of the web whereas the material of the substantially larger size of 2:1 is used on the opposite side of the web. To balance this, it is expedient, in the case of the blank following next, to transpose in terms of sides the arrangement of base blank 24 and the remaining blanks 25, so that the resin-impregnated mat is used uniformly on the right and left. Also, as far as the distribution of the blanks on the web of resin-impregnated mats is therefore concerned, a flexible cutting to size and handling of the resin-impregnated mat is required. In addition, the parts have to be picked up from a flat and gap-free base.

In the exemplary embodiment illustrated in FIG. 3, the reference blank 24 is not only weighed when it is placed onto the weigher 15, but at the same time also pre-formed in a stepped manner, as is expedient later for inserting the finished stack of resin-impregnated mats 31 into the mold. It should be emphasized that this is a special case of a workpiece which is critical in this regard; such workpiece must be selected in the present instance, however, in order to be able to demonstrate the range of handling options for the suction gripper according to the invention to its full extent. Therefore, for the purpose of a stepped pre-forming of the resin-impregnated mat 24, a stacking device 17 is fastened on the weighing plate 16 of the weigher, said stacking device permitting stepped pre-forming of the reference blank by the handling robot 7 and the gripper of the resin-impregnated mats 27. The other blanks 25 are stacked up on the lower or upper step of the base blank 24. This also places high requirements on the handling device.

For automated handling of resin-impregnated mat blanks of differing shape and size, the invention provides a suction gripper 27 which can be manipulated by a multiaxially moveable handling robot 7. In order to be able to grasp the resin-impregnated mats simultaneously at a plurality of points on the top side, a large number of suction bells 35 are arranged on the lower side of the suction gripper 27. The suction bells point downward with their open side and, and their edge 38 can be situated or brought together in a suction bell plane 36. The suction bells are distributed in the manner of a grid over an area which corresponds to the largest resin-impregnated mat which is to be handled.

The mutual transverse distance t between the suction bells 35 within the grid is dimensioned in such a manner than the smallest resin-impregnated mat which is to be handled still covers at least two suction bells 35. Each suction bell 35 can be activated individually in each case via a separate connection 37 and can be actuated by a vacuum. The suction bells, which consist of an inflexible material, have an edge 38 which tapers to a point in cross section in the manner of an annular cutting edge and has an approximately cylindrical inner and outer surface in the region near the edge. In addition, each suction bell is guided in an axially moveable manner (such that it can be lifted orthogonally to the suction bell plane 36 and, in response to a particular control command, can be displaced independently in each case very rapidly from a rest position into a picking-up position offset axially therefrom) as explained in greater detail below in conjunction with FIGS. 10a, b; 11a, b, c, d; and 12a to 12e. In the exemplary embodiment illustrated in the drawings, the axially moveable guidance of the suction bells is achieved by the fact that each suction bell is connected to the piston rod 46 of a pneumatic working cylinder 45, which can be activated independently in each case.

For the sake of completeness, it should be mentioned at this point that, in a simple version of the suction gripper, instead of the suction bells being guided by piston rods of a pneumatic working cylinder, a simple rod guidance would also be possible, with the suction bell being accelerated from a locked rest position in the direction of the working position by a prestressed spring. Individually activatable solenoids can be used to release the lock for individual suction bells, and the rapid transfer of the activated suction bells into the working position is thereby carried out. The return of the suction bells into the locked rest position could be brought about by the suction gripper being pressed by the handling robot together with the suction bells onto a flat base. As a result, all of the suction bells are pressed back together into their rest positions where the locks automatically engage.

As mentioned, the suction bells consist of an inflexible material (for example stainless steel, brass, aluminum or a hard plastic) which is inert to the material of the webs of resin-impregnated mats. Owing to the abovementioned materials, the suction bells do not yield under a vacuum, but retain their shape under a different application of force. Because of a possible wear of the suction bells during the serial use of the suction gripper on account of continuously recurring brush cleaning (in particular the cutting-edge-like edge of the suction bells), a wear-resistant material (i.e., especially steel), is preferred, at least in the edge region 38.

In order to ensure a vacuum-resistant seal of the hard suction bell on the web of resin-impregnated mats, the edge 38 of the suction bell tapers to a point in the shape of a V in cross section, in the manner of an annular cutting edge; however, the frontmost edge of the annular cutting edge should be slightly rounded in order to avoid any risk of damaging fibers. Owing to the V-shaped cross section, the edge presses into the surface of the resin-impregnated mat, in particular when the suction bell is struck when set down at a certain speed onto the resin-impregnated mat and especially also if the required suction bells are not all set down simultaneously, but rather with a slight offset in time. Although this sinking-in is reinforced by the subsequent vacuum actuation of the suction bell, a certain sealing of the suction bell with respect to the resin-impregnated mat must be ensured initially, thereby permitting a reliable build up of vacuum in the suction bell.

The set-down force of the suction bells 35 onto a resin-impregnated mat to be picked up and the depth to which the edge burrows into it has to be determined empirically for each case. In the case of soft and/or very level resin-impregnated mats, a pressure of, for example, 2 bar in the pneumatic cylinders may suffice in order to be able to achieve a good seal in every case. In the case of harder and/or uneven resin-impregnated mats, this may, under some circumstances, be achieved only by a higher working pressure.

In spite of the small contact surface area, the risk exists that the suction bells become dirty through the repeated and intimate contact of the suction bells 35 with the sticky resin-impregnated mats. Adhering residues of plastic material cure over time and impair the seal tightness of the set-down suction bells. In order to minimize the dirtying possibility solely by means of the shaping, the suction bells are configured to be approximately cylindrical on the inside and outside, at least in the region near to the edge. In order nevertheless to prevent synthetic resin from concentrating on the suction bells, an assemblage of rotationally drivable cleaning brushes 55 (which are of cylindrical design in the exemplary embodiment illustrated in FIG. 1) is arranged in the action region of the handling robot 7. The cleaning brushes are arranged horizontally on the upper edge of a container 56, and are driven by a drive 57.

In order to clean the suction bells, the suction gripper 27 is moved back and forth over the circumference of the cleaning brushes, with adhering plastic material being scraped off from the edges 38 of the suction bells and being collected in the container 56. If required, the suction gripper may be scraped over the revolving brushes with the suction bell field oriented differently—longitudinally, transversely, diagonally—with respect to the circumferential direction of said revolving brushes.

Apart from purely cylindrical cleaning brushes, profiled cleaning brushes are also possible, in which the envelope over the bristle ends has, for example, the profile of a toothed wheel. It may be expedient in this case if the profiles run inclined with respect to the axial direction in the manner of a screw flight. Also nubbly profiles of the envelope over the bristle ends may, under some circumstances, provide an improved cleaning result in comparison with a cylindrical brush.

So that the particles scraped away from the suction bells by the brushes can collect, because of the force of gravity, in the container 56 surrounding the cleaning brushes, in the exemplary embodiment illustrated in FIG. 1, the latter are mounted horizontally in the region of the upper edge of the containers. It should be emphasized here that the cleaning brushes should be mounted in an easily exchangeable manner in the containers in order to be able to be exchanged rapidly for new or clean brushes should the brushes themselves become dirty. A possible cleaning of the brushes may, if required or if possible, be carried out in a separate maintenance workshop. Initial experiences with the cleaning system indicate that the bristles of the cleaning brushes have to be very hard and stiff in order to be able to obtain a reliable cleaning effect.

In order also to design the interior of the suction bells in a manner such that they are favorable for cleaning, the rotationally symmetrical interior space, which is enclosed by a suction bell 35 above the edge 38, is relatively flat. The interior space has an axial height h of approximately 25 to 40% of the edge diameter d. In addition, the top-side base 39 of the interior space surrounded by the suction bell 35 merges in a rounded manner into the circumference and has itself a surface shape similar to a spheroid in the manner of a kettle base. The interior space of the bell should not be too flat, because there is otherwise the risk that the resin-impregnated mat, which bulges into the interior of the suction bell under the effect of a vacuum, will touch the bell base 39. By means of this contact, the bell base could not only be unnecessarily contaminated with resin, but the surface area over which the vacuum is effective could be reduced in comparison with the circular surface area enclosed by the bell edge 38.

In order to build up a certain minimum force on each suction bell under the effect of a vacuum, the suction bell should not be too small. It is therefore recommended to dimension the diameter d of each suction bell 35 at its edge 38 to approximately 2.5 to 10 cm, (preferably approximately 3 to 4 cm), which corresponds in round figures to an enclosed surface area of 5 to 78 cm² (preferably approximately 7 to 12 cm²). The larger suction bells are preferred in the case of stronger and/or more flexurally rigid resin-impregnated mats. Application of a vacuum of 0.7 bar (a moderate value) then enables a retaining force of approximately 15 to 230 N (preferably of approximately 21 to 35 N) to be built up per suction bell; at 0.5 bar it would be 25 to 390 N (preferably approximately 35 to 60 N). Taking into account the abovementioned design of the interior space of the suction bell such that it is flat and favorable for cleaning, the clear volume of each suction bell should expediently be approximately be 3 to 300 cm³ (preferably approximately 5 to 20 cm³). These volumes can be evacuated very rapidly.

In order for the resin-impregnated mats to be picked up such that they are as flat as possible, (i.e., have little sag), a small mutual transverse distance between the suction bells within the grid-like distribution of the suction bells is strived for. A particularly large number of suction bells can be accommodated per unit of area in a grid of hexagonal design. However, for manufacturing reasons, a more simply designed, orthogonal grid is to be preferred. The orthogonal basic structure of the grid is also advantageous in that between the individual rows of suction bells (which are mounted in a manner such that they can be lifted) narrow passages must be left free in each case to accommodate extendable fixing spikes 64 to 66, which will be discussed in more detail below.

The grid spacing t, which forms the basis of the superficial distribution of the suction bells 35 in the suction bell plane 36, need not be equal in size in the longitudinal direction and transverse direction, although an at least approximately equally sized spacing will be sought. The grid spacing may also assume different values over the area of the suction gripper as a whole. For example, it may be expedient to arrange smaller suction bells at a small spacing in the center of the suction gripper in order to enable small mat blanks to be handled in a sag-free manner. However, the suction bells arranged in the edge region of the suction gripper are required only for handling large mat blanks. Accordingly, a relatively large spacing of relatively large suction bells suffices. In every case, the spacing within the suction bells distributed in the manner of a grid should be at least 120 to 150% of the diameter d of the suction bells 35.

In order for to match the suction bells 35 to the shape of the mold when the resin-impregnated mats are laid onto the impression of the mold, an elastic intermediate element 40 is attached above the suction bell in the mounting of the suction bells. This intermediate element automatically permits an elastic pivoting of the suction bell to a certain extent even when the resin-impregnated mats are being deposited onto the impression. In the exemplary embodiment illustrated in the figures, this intermediate element 40 essentially comprises a round rubber part with a waist, with threaded plates fastened on its top and bottom sides. Moveable tension elements which are integrated in the rubber ensure that the intermediate element is virtually inflexible in the axial direction.

As an alternative, an intermediate element of this type could also be formed by a helical spring or by an expansion bellows, with axial inflexibility being ensured by means of integrated, moveable tension elements. This elastic intermediate element is expedient both in the case of a suction gripper construction having a large suction bell lift H, and in the case of a simple construction with only a small suction bell stroke caused by the setting-down process.

In the interest of structural simplicity of the vacuum feed to the suction bells 35, and in order to avoid moveable hose lines in the working region of the suction bells, which are mounted in a manner such that they can be lifted, the piston rods 46 of the lifting cylinders and, if appropriate, the elastic intermediate elements 40 are each provided with a hole 50, 50′ which passes axially through them and through which the vacuum can be fed to the respectively associated suction bell. The piston rods 46 are led out on the top side through the cylinder head 54 in a sealing manner in each case. The vacuum connections 37 for the suction bells 35 arranged in each case on the upper piston rod ends. Moveable and vacuum-tight hose lines lead from the piston rod ends to a collecting line, which is arranged immovably on the suction gripper. This collecting line is connected via a main line, which is laid moveably on the robot arm, to a vacuum source set up in a fixed position in the manufacturing hall. In this context, it should be mentioned that, in order to produce a vacuum, use is not made—as otherwise customary—of Venturi nozzles, but rather preferably of volumetrically acting extractors. Efficient extractors of all types permit not only a rapid evacuation of the suction bells, but also a certain amount of additional air to the suction bells without noticeable losses in the level of the vacuum.

In the exemplary embodiment illustrated in the drawings, each of the suction bells is mounted at the free end of the piston rod 46 of a lifting cylinder 45, which lifting cylinders are fastened inflexibly in the suction gripper 27. Each lifting cylinder can be activated and subjected to pressure individually via the connection 48 in respect of the piston space on the top side (i.e., “lowering”), or via the connection 49 in respect of the piston space on the lower side (i.e., “lifting”). As a result, any desired selection of suction bells can be raised or lowered orthogonally to the suction bell plane 36. It is also possible to subject the lower side of the pistons of all of the pneumatic cylinders continuously and uniformly with one and the same, moderate pressure, for example with one bar, in the “lifting” direction. This pressure on the lower side thus acts as a pneumatic return spring. A maximum lift H between the uppermost and the lowermost position of the suction bell is possible corresponding to the length of the lifting cylinders 45. A large lift of the suction bells is required for a stepped depositing of the resin-impregnated mats or for an insertion of the resin-impregnated mats into the mold 18.

If a large bell lift H is not required (i.e., if the resin-impregnated mats are only to be picked up from a level state and are also to be deposited in an approximately level state), then it suffices to have a small lift of the suction bells, which should be large enough to reliably protect those which are not required in some cases from making contact with the resin-impregnated mat to be handled. Such a lift is also expedient for an acceleration of the suction bells to be activated out of a raised rest position, so that they can be set down onto the resin-impregnated mat at a certain minimum speed, such that the bell edge can burrow in a sealing manner into the mat surface on account of the impact momentum. In such a simple construction of the suction gripper with little suction bell lift, a piston restoring spring which is integrated in the pneumatic cylinder suffices in each case to return the piston. With this suction gripper construction, the working position of the suction bell always corresponds to that position of the pneumatic cylinder in which it is completely extended as far as the end of the stroke of the piston.

The suction gripper is a serial tool which in some cases is optimized in respect of the particular application. If the workpiece which is to be produced is relatively flat in the finished state, a suction gripper with a small suction bell lift will also be used. In addition to the weight advantage and the simple constructional form of the pneumatic cylinders, this would have the substantial advantage that the suction gripper has a small constructional height overall. This is advantageous because, in the case of a suction gripper having a small overall height, the mold needs to be opened only by a correspondingly small amount to load it with new resin-impregnated mats. The smaller the degree to which the mold is opened, the smaller is the degree of cooling thereof in the opening times required for reloading it, and the more rapidly does the mold reach its desired temperature again after it is closed. A small constructional height of the suction gripper, small opening height of the mold when reloading it, small degree of cooling of the same in the interruption times and shorter cycle times are therefore directly associated with one another.

With the suction gripper 27, the resin-impregnated mats are not only to be picked up from the cutting table 3 and stacked up, but also the stack of resin-impregnated mats or resin-impregnated mats which are to be inserted are also to be deposited in an exact position and in a manner corresponding in shape onto the impression of the mold. For this purpose too, the mobility of the suction bells 35 over a relatively large lift H is provided. The relatively large constructional height of the suction gripper and the associated larger opening of the mold in the loading intervals have to be accepted.

In the case of a large bell lift H, in order also to be able to permit and fix any desired intermediate positions of the suction bell, that freely accessible part of the piston rod 46 of the lifting cylinder 45 which is led out of the top side from the cylinder head 54 has arranged on it a respective annular piston rod brake 52 which is displaceable in a smooth-running manner axially on the piston rod (i.e., under some circumstances also just by its own weight). Each of the piston rod brakes is in each case independently activatable and provided with a control connection 53. An activation enables the piston rod brake to be fixed on the piston rod in the relative position present in each case.

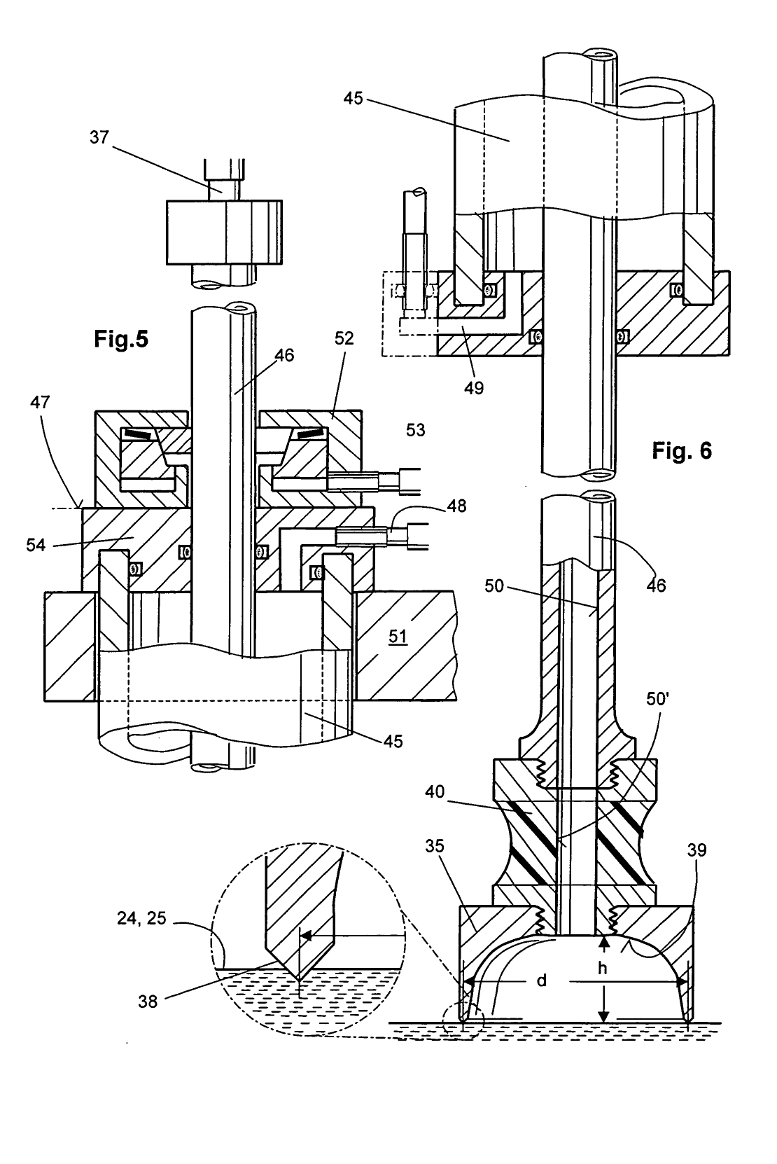

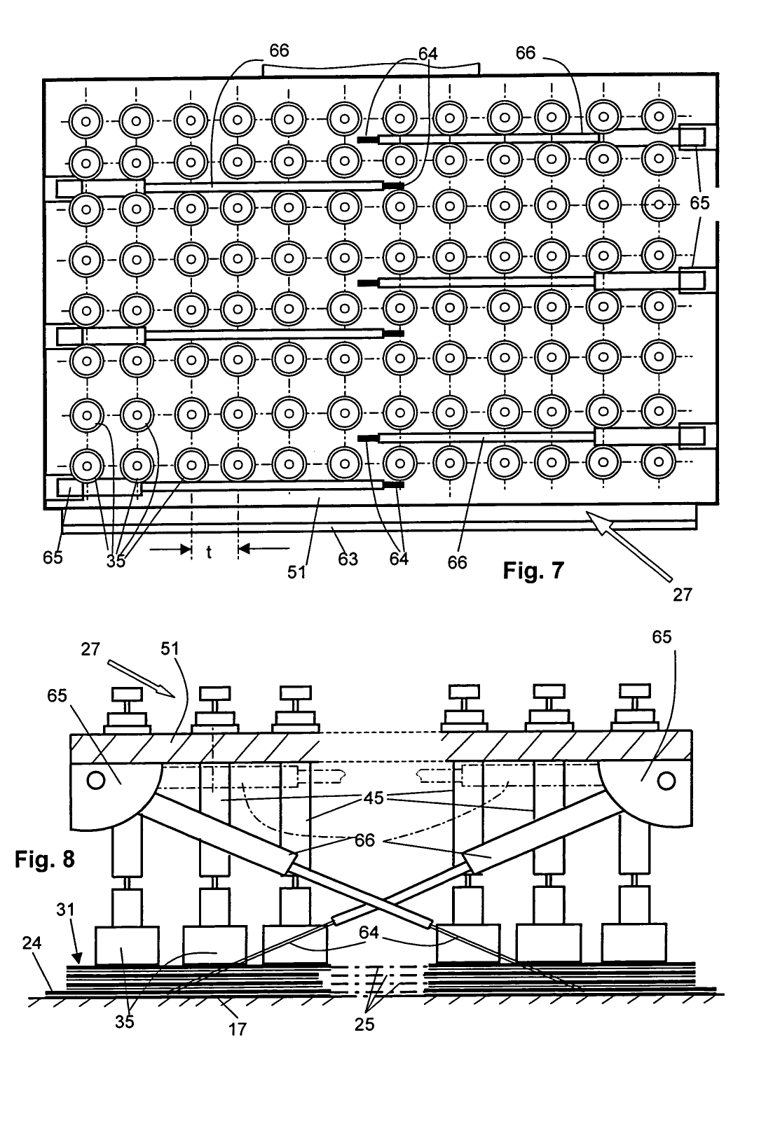

Without activation of the piston rod brake 52, the latter bears loosely because of the force of gravity, or owing to a screw connection on the end side, against the upper end side 47 of the cylinder head 54, specifically irrespective of the particular lifting position of the piston rod 46 and of the suction bell 35. The exemplary embodiment illustrated in FIG. 5 shows a pneumatic construction of the piston rod brake 52. By means of an annular piston, which can be pressurized on the lower side and displaced counter to the force of a resetting spring, a radially slotted brake cone can be compressed radially via conical surfaces, the brake cone thereby surrounding the piston rod in a frictional manner and fixing the latter in place. A downward movement of the piston rod is then no longer possible, because the brake 52, which is secured on the piston rod, bears against the top side 47 of the piston head. After the annular piston is relieved of load, it is lowered by the resetting spring, so that the brake cone can spring up radially again and release the piston rod.

In spite of the effort to seal off the suction bells effectively with respect to the mat surface, in individual cases it may nevertheless happen that an individual activated suction bell does not provide a neat seal, whether because the resin-impregnated mat is extremely uneven at the set-down point of the suction bell 35, whether because a foreign body has become caught on the edge 38 of the suction bell, or whether because the suction bell has been set down too close to the edge of the resin-impregnated mat blank and is not completely covered by the resin-impregnated mat or the mat edge is sucked under the effect of the vacuum into the suction bell and a leak thus arises. Should one of the suction bells have a relatively large leak, there is the risk that a sufficiently high vacuum cannot be built up or maintained in the other suction bells connected pneumatically in parallel, because a certain amount of additional air also continuously flows into the other suction bells via the suction bell which has become leaky.

In order to prevent the vacuum in the entire suction gripper from collapsing because of a leak on one suction bell, it is expedient if a respective, automatically responding safety restrictor is provided in the vacuum inlet of each suction bell. This safety restrictor is designed, on the one hand, in such a manner that it becomes effective only with a time delay after a vacuum has been switched on. The delay time is dimensioned so that, under normal circumstances, the vacuum, which has been completely switched on, can readily build up in the associated suction bell. Only after expiration of the delay time does the safety restrictor transfer (if appropriate) into a severely restricting state (namely under the further condition that afterwards a large difference in pressure continues beyond the safety restrictor). In the severely restricted state, only small amounts of gas are let through without obstruction, for example because of gas being discharged from the resin-impregnated mats. The safety restrictor in the restricting state constitutes a considerable flow obstacle for larger amounts of air caused by leakage. This prevents the vacuum in the line system of the suction gripper from collapsing if a local leak should occur. On the contrary, a vacuum is nevertheless maintained at least at a sufficient level in the entire system of the vacuum lines arranged in the suction gripper. After the vacuum in the previously activated suction bells have been switched off, the activated safety restrictors automatically and rapidly return from the restricting state into the open passage state.

A complete range of handling processes also includes the handling of a stack of mats 31 formed from a plurality of resin-impregnated mats. The suction gripper according to the invention enables the individual resin-impregnated mat blanks 25 when placed on one another also to readily press on one another, with the result that the layers which have been stacked up separately already adhere to one another because of the stickiness of the resin. In principle, at least if the number of layers is not too large and/or if the mats are not too heavy a stack of mats 31 formed in this manner could be handled solely by grasping the uppermost layer by the suction bells. In this case, however, the risk cannot be dismissed that, under some circumstances, the lowermost layer or a plurality of layers arranged right at the bottom could partially become detached from the grasped stack during the transportation.

In order reliably to prevent individual layers from becoming detached from a stack of mats which is to be handled, pivotable spike guides 66 having gripping spikes 64 which can be extended telescopically in a controlled manner are arranged on the edge and/or within the grid field of the suction bells 35. Each of the spike guides can be pivoted back and forth in a controlled manner by means of a drive 65 between two end positions determined by adjustable stops. In one end position (withdrawal position, indicated by chain-dotted lines in FIG. 8), the spike guide is placed flat against the lower side of the base plate 51 of the suction gripper and pivoted back behind the suction bell plane 36. In the other end position (working position, which is set upright with respect to the suction bell plane 36 and is shown in FIG. 8 in solid lines), the spike guides 66 are oriented at an inclination to the resin-impregnated mat 24, 25, 31 to be picked up.

After the suction bells 35 of the suction grippers have been set down correctly onto the uppermost layer of the stack of resin-impregnated mats 31 and after the spike guides have been set upright into the working position, the fixing spike 64 can be telescopically extended and inserted at an acute angle into the mat layers of the stack. During this process, the stack of mats still rests on the base 17. The insertion depth of the fixing spikes can be adjusted, specifically such that the lowermost layer of the resin-impregnated mats is still securely grasped. The fixing spikes are inserted through as far as the table surface. It should be emphasized that the insertion direction is placed toward the edge (i.e., the point at which the uppermost layer is perforated) is situated further away from the edge than the point at which the lowermost layer is perforated. Above all, the lowermost layer 24 of the stack of mats should be secured as close to the edge as possible.

After the suction bells have been actuated by a vacuum and the stack of mats is secured by the inserted fixing spikes 64, the suction gripper can be raised and the stack of mats can be lifted, together with it, off the flat base. In this case, it is expedient if the suction gripper first executes a slight tilting movement in order to be able to detach the lowermost mat 24 sticking to the base 17 more easily, that is from the edge. The vertically directed loads which occur in the process within the stack of mats do not need to be absorbed via the long lever arm of the fixing spikes 64 and the spike guides 66. On the contrary, the fixing spikes 64 are securely supported on the uppermost layer of the stack, which layer is secured on the suction bells by means of suction forces; only the small spike piece inserted into the stack of mats is subjected to a bending stress in the vertical direction.

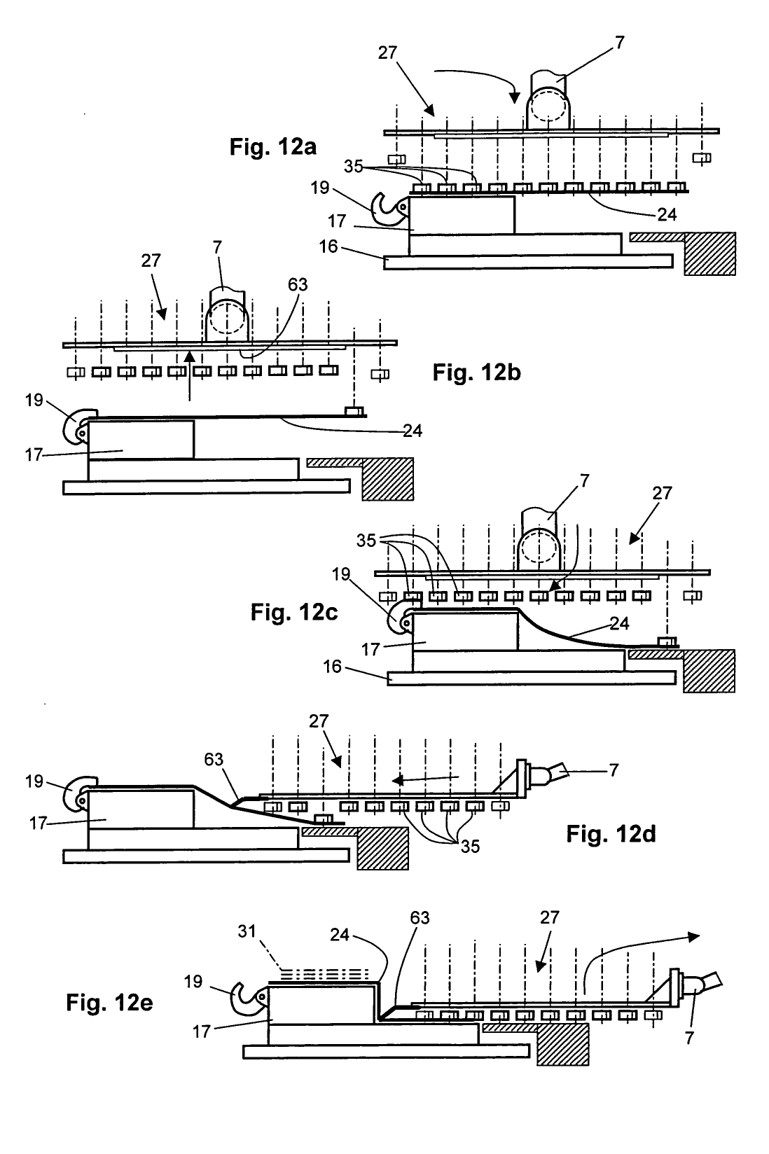

In order to demonstrate the universal of applicability the suction gripper according to the invention, the particularly difficult special case which has already been discussed in conjunction with FIG. 3 will be dealt once again below. This special case involves the necessity of having to deposit a mat blank 24 into the impression of the lower mold in a stepped manner out of consideration for certain peculiarities in the shape of the workpiece to be produced. For this purpose, the mat blank has to be deposited beforehand in a stepped manner onto an appropriate preforming device 17. In this case, the resin-impregnated mat is inserted neatly into the hollow edge of the step. For this purpose, a strip-shaped insertion tool 63 which protrudes laterally from the suction gripper 27 is fastened to a longitudinal side of the base plate 51 of said suction gripper. The manner of operation with this insertion tool will be discussed in greater detail below in conjunction with FIGS. 12a to 12e.

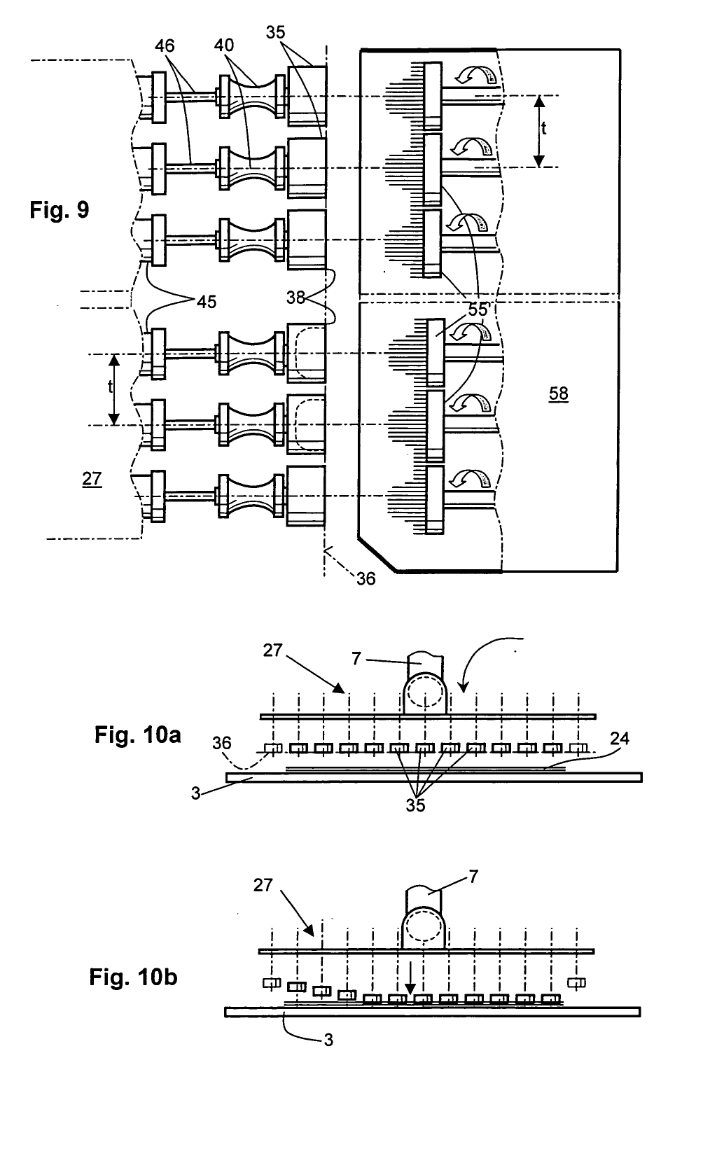

As has already been mentioned above, the edges 38 of the suction bells are to be cleaned at regular time intervals by brushing the suction bells over rotating cleaning brushes 55 in order to avoid accumulation of synthetic resin on the suction bells. FIG. 9 shows the process of cleaning the suction bells on an enlarged scale in comparison with the illustration of FIG. 1 and as seen from the side. However, a different system of cleaning brushes 55′ is used in the exemplary embodiment illustrated in FIG. 9.

One particular feature of the cleaning arrangement according to FIG. 9 is that the rotating cleaning brushes 55′ shown there correspond to the grid-type arrangement of the suction bells and are likewise arranged in the manner of a grid and in an identical grid, with the bristles of the cleaning brushes being held in a round brush board which is situated with its axis perpendicular to the axis of rotation. Each suction bell is assigned its own cleaning brush in each case. These bristles of the cleaning brushes differ in length, specifically are shorter at the outer edge than in the center of the brush, thus resulting in the cleaning brush having a profiled shape which is matched to the clear cross-sectional shape of the suction bell. In the case of the exemplary embodiment illustrated in FIG. 9, the cleaning brushes 55′ are all arranged in a vertical plane, so that the particles which are brushed off cannot fall into the driving mechanism of the brushes. The cleaning brushes 55′ according to FIG. 9 are also mounted in the corresponding container 58 in a manner such that they can easily be exchanged, in order to be able to exchange them rapidly for new or clean brushes in the event of becoming dirty.

To clean the suction bells using a device according to FIG. 9, the suction gripper 27 is carefully pressed axially into the rotating cleaning brushes with the suction bell plane 36 oriented vertically and with the grid of the suction bells and of the cleaning brushes in a corresponding position. To improve the cleaning action, the suction gripper may carry out a small circular movement while being offset parallel in the suction bell plane.

Now that the structural features of the suction gripper 27 according to the invention have been described, its manner of operation will be discussed below.

Picking up of an individual resin-impregnated mat blank with the suction gripper from a flat base is shown in two phases in FIGS. 10a and 10b. (Reference is also made below to FIGS. 5 and 6 with regard to individual structural features of the suction gripper). First of all, according to FIG. 10a, the suction gripper is held by the handling robot with the suction bell plane 36 at a close distance above the resin-impregnated mat to be picked up from the cutting table 3. From this gripper position in which it is ready to picked up, the suction bells are then moved independently toward the mat blank, with a small offset in time between the individual axial strokes of the suction bells being advantageous. The suction bells strike with their edge into the resin-impregnated mat, so that they burrow into it and thereby provide an effective seal. At the same time as the impact of the suction bells, the respective vacuum is switched on and the respective piston rod brakes 52, which bear on the top side (47) against the cylinder head 54, are activated. Owing to the securely clamped piston rod brakes, each of the piston rods 46 is fixed in the downward direction in the particular picking-up position. As a result, the pneumatic cylinder is able to pick up a load without an axial movement of the piston rod. The greatest load of the suction gripper occurs in particular when the resin-impregnated mat blank 24 adhering to the base 3 is being detached. The level state of the picked-up resin-impregnated mat is retained during the lifting-off process and during the entire transporting distance because the resin-impregnated mat is held securely and in a level, virtually sag-free state by a large number of suction bells which lie in a common plane and are fixed in their lifting mobility.

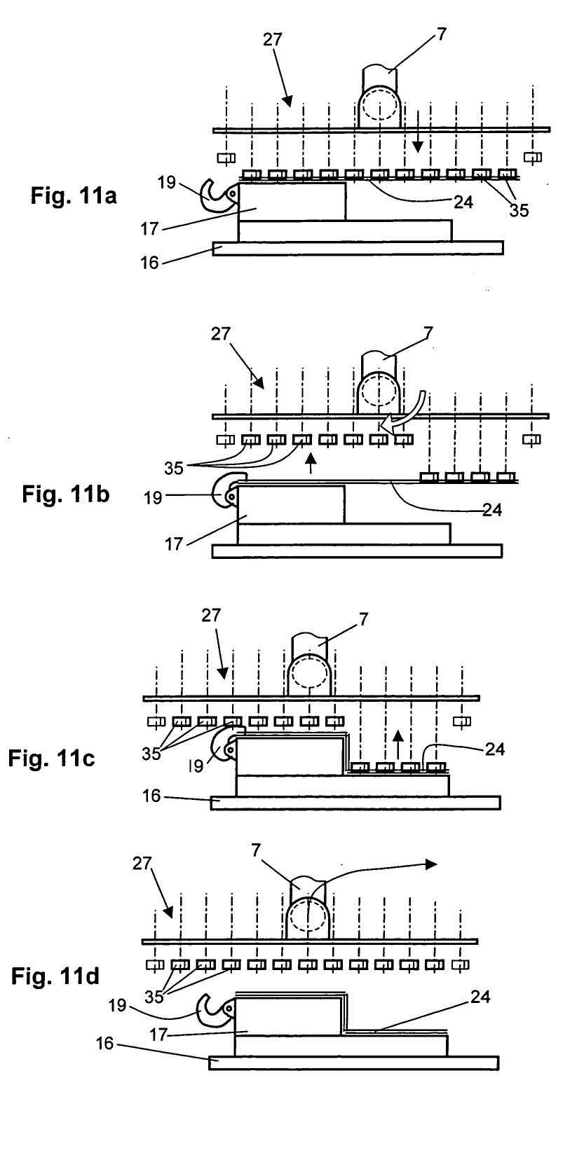

The deposit of the picked-up resin-impregnated mat blank onto a level base proceeds very simply and in principle does not require any special explanation. Therefore, the more difficult special case of depositing the resin-impregnated mat 24 onto a stepped stacking device 17 without the suction gripper engaging around the mat will be addressed with reference to the four-part sequence of pictures of FIGS. 11a to 11d:

First the suction gripper 27 and the resin-impregnated mat 24 suspended on it are brought by the handling robot 7 close enough to the upper step of the stacking device that the resin-impregnated mat touches the deposition surface (phase I according to FIG. 11a), with, of course, the correct horizontal position of the resin-impregnated mat also being brought about. The lateral clamping strip 19 is initially still open.

Then, after the clamping strip 19 has been transferred into the clamping state, with the gripper position maintained immovably, the suction bells situated in the region of the upper deposition step and those situated in the mat region for the subsequently vertical section of the resin-impregnated mat are ventilated and raised. The other suction bells, which are assigned to the mat section of the lower deposition step, remain active (phase II according to FIG. 11b). The closed clamping strip 19 prevents the blank 24 from slipping away laterally under the effect of the horizontal pull caused by the force of gravity.

Starting from this intermediate state of the deposition process, the suction gripper is offset in parallel on a circular arc while maintaining the horizontal position. The mat section which is assigned to the lower deposition step is moved from the raised position toward the lower deposition step. In the process, the mat section which is assigned to the vertical part of the step is placed onto this vertical deposition surface (phase III according to FIG. 11c).

Now, with the gripper position still unchanged initially, the as yet still activated suction bells of the mat section of the lower deposition step can also be ventilated and withdrawn into the suction gripper; that is, raised into the starting position ready to pick up (phase VI according to FIG. 11d). The suction gripper is then ready to take up a new resin-impregnated mat. The clamping strip 19 can be opened again.

In the case of the method described in connection with FIGS. 11a to 11d for the ordered, stepped deposition of a resin-impregnated mat, it may happen, under some circumstances, that that part of the resin-impregnated mat which is assigned to the vertical step section does not bear entirely smoothly or not always uniformly there. If the subsequent molding process or the corresponding mold should require that the resin-impregnated mat part (which is later situated vertically) also bear very smoothly against the step surface, then, under some circumstances, a better deposition result can be achieved by means of the method according to the sequence of FIGS. 12a to 12e, in which five phases are illustrated:

The first phase shown in FIG. 12a corresponds entirely to the first phase according to FIG. 11a, and reference is made to the above description.

Also the second phase according to FIG. 12b is very similar to that according to FIG. 11b. The only difference is that the resin-impregnated mat blank 24, after the correct deposition on the upper step by the suction gripper 27, is secured only on the mat edge which is situated opposite the upper step by the last row of suction bells.

For the further procedure, an auxiliary deposition surface, indicated in FIGS. 12a-e by hatching is required laterally next to the deposition surface of the lower step. In the third phase according to FIG. 12c, the mat edge which has previously still been held by the suction gripper, is lowered and deposited on the auxiliary surface in a manner offset laterally with respect to the lower deposition step, with the resin mat sagging in the manner of a garland from the free edge to the upper deposition step.

The suction gripper must now engage around and pick up this provisionally deposited mat edge with another row of suction bells again, the strip-shaped insertion tool 63 being placed onto the resin-impregnated mat 24 at a distance, corresponding to the height of the step, from the free step edge. The row of suction bells situated closest to the mat edge in this gripper position is placed onto the resin-impregnated mat and activated (i.e., actuated by a vacuum), and the piston rods with the movable brake 52 are fixed in place (phase IV according to FIG. 12d).

After this engagement process, the last part of the correct deposition of the mat 24 in the region of the lower step can then begin. In this case, the insertion tool 63 is moved into the hollow edge of the step. During this gripper movement, both the mat part which is subsequently situated vertically and the mat part which is situated horizontally on the lower step are kept stretched out. Only a moderate vacuum is switched on in the one row of suction bells that again secure the mat edge, with the result that the held mat can also slide slightly over the suction bell. It can thereby be ensured that the resin-impregnated mat is deposited on the stepped stacking device 17 following the step shape in a manner true to its contours. Subsequently, the last suction bells are deactivated and raised and the suction gripper is removed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-33. (Cancelled)

34. A method for automatically handling resin-impregnated mats of differing shape and size during production of SMC components, using a gripper which can be manipulated by a handling device, that can be moved multiaxially, said method comprising:
providing the resin-impregnated mats on a flat and level base;
grasping the resin-impregnated mats on a flat surface on a top side thereof, by means of a vacuum acting simultaneously at a multiplicity of attachment points,
picking up the resin-impregnated mats in a substantially sag free state; and conveying them to a mold;
using a plurality of suction bells, which are made of an inflexible material and are provided on a contact side thereof with an edge that tapers to a point in the manner of an annular cutting edge in cross section, for transferring the vacuum from the suction gripper into the surface of the resin-impregnated mats;
pressing the suction bells in a sealing manner into the surface of the resin-impregnated mats before the vacuum is established; and
after the resign-impregnated mats which have been conveyed are deposited, mechanically cleaning edges of the suction bells by means of rotating brushes.

35. The method as claimed in claim 34, wherein
the suction bells are activated by vacuum actuation and arranged in a grid pattern; and
said suction gripper is matched in shape and size to a particular resin-impregnated mat that is to be handled, by a corresponding selection of the shape and size of the grid field of the suction bells of the suction gripper.

36. The method as claimed in claim 34, wherein
when deposited into a mold, the resin-impregnated mat is matched by the suction gripper to a shape of the mold, and inserted into an impression thereof.

37. The method as claimed in claim 36, wherein insertion of the resin-impregnated mat takes place by a lifting movement of the suction bells in relation to the suction gripper.

38. The method as claimed in claim 36, wherein insertion of the resin-impregnated mat takes place by
first partially depositing one half of the resin-impregnated mat, with the suction gripper positioned obliquely;
after the inserted half has been released from the suction gripper, pivoting the gripper; and
thereafter, depositing the second half of the resin-impregnated mat.

39. The method as claimed in claim 36, wherein insertion of the resin-impregnated mat takes place by bending of the suction gripper about a pivot axis lying in a suction bell plane.

40. The method as claimed in claim 34, wherein the step of conveying a multilayer stack of resin-impregnated mats, comprises:
grasping a resin-impregnated mat situated uppermost in the stack, on a top side thereof, using a vacuum; and
mechanically fixing the layers of resin-impregnated mats situated beneath on the uppermost layer by means of fixing spikes inserted at an inclination at the edges.

41. A device for automatically handling resin-impregnated mats of differing shape and size during production of SMC components, said device having a suction gripper which can be manipulated by a handling device and moved multiaxially, for grasping the resin-impregnated mats on a top side thereof simultaneously at a plurality of points, wherein:
a lower side of the suction gripper is provided with a multiplicity of suction bells, each having a downwardly directed open end with edges of said bells situated jointly in a suction bell plane;
said bells are distributed in a grid over an area which corresponds to a largest resin-impregnated mat which is to be handled;
a mutual transverse distance between the suction bells within the grid is dimensioned such that a smallest resin-impregnated mat which is to be handled covers at least two suction bells;
each of the suction bells is activatable individually by a vacuum;
the suction bells, consist of an inflexible material;
the suction bells have an edge that tapers to a point in cross section, in the manner of an annular cutting edge, and an approximately cylindrical inner and outer surface in a region near to the edge;
at least one rotationally drivable cleaning brush is arranged in an action region of the handling device manipulating the suction gripper; and
the edges of all of the suction bells can be brought into cleaning contact with said cleaning brush.

42. The handling device as claimed in claim 41, wherein each suction bell is mounted so that it can be lifted axially and orthogonally to the suction bell plane and is connected in each case to a force accumulator, which can be controlled separately, in such a manner that each suction bell, in response to a particular control command, can be accelerated independently from a rest position into a picking-up position offset axially therefrom.

43. The handling device as claimed in claim 41, wherein:
each suction bell encloses a rotationally symmetrical interior space; and
the interior space has an axial height of approximately 25 to 40% of an edge diameter of each bell.

44. The handling device as claimed in claim 41, wherein a top-side base of the interior space surrounded by a suction bell has a surface shape which is rounded from a circumference to the base in a spheroidal manner.

45. The handling device as claimed in claim 41 wherein a diameter of each suction bell is approximately 2.5 to 10 cm, at its edge.

46. The handling device as claimed in claim 41 wherein the diameter of each suction bell is approximately 3 to 4 cm, at its edge.

47. The handling device as claimed in claim 41, wherein a clear volume of each suction bell is approximately 3 to 300 cm³.

48. The handling device as claimed in claim 41, wherein a clear volume of each suction bell is approximately 5 to 20cm³.

49. The handling device as claimed in claim 41, wherein spacing between suction bells in the suction bell plane is approximately 120 to 150% of a diameter of the suction bells.

50. The handling device as claimed in claim 41, wherein the grid formed by a distribution of the suction bells in the suction bell plane is of hexagonal or orthogonal design.

51. The handling device as claimed in claim 41, wherein each suction bell is connected to the suction gripper at least indirectly via an intermediate element comprising one of rubber, a helical spring, and an expansion bellows, which is attached to a top side of the suction bell and permits elastic pivoting.

52. The handling device as claimed in claim 51, wherein:
the intermediate element is of hollow design axially; and
a vacuum connection belonging to an associated suction bell is arranged above the intermediate element so that the vacuum can be fed to the suction bell through the intermediate element.

53. The handling device as claimed in claim 41 wherein a plurality of cylindrical cleaning brushes are arranged parallel and adjacent to one another in a horizontal plane in an action region of the handling device which manipulates the suction gripper.

54. The handling device as claimed in claim 53, wherein:
outer ends of bristles of the cylindrical cleaning brushes form a profiled envelope, as seen in the axial direction; and
axially running strips of longer bristles alternate in the circumferential direction with strips of shorter bristles.

55. The handling device as claimed in claim 52, wherein the axially running strips of longer bristles and the strips of shorter bristles situated in between are inclined relative to the axial direction and run along a steep screw-flight line.

56. The handling device as claimed in claim 41, wherein:
a multiplicity of rotating cleaning brushes are arranged in a planar grid identical to a grid of the suction bells;
the bristles of the round cleaning brushes are oriented at least approximately parallel to an axis of rotation; and
each suction bell is assigned a dedicated cleaning brush.

57. The handling device as claimed in claim 56, wherein:
the bristles of the cleaning brushes differ in length; and
said bristles are shorter at the outer edge than in the center of the brush;
whereby the cleaning brush has a profiled shape matched to clear cross-sectional shape of the suction bell.

58. The handling device as claimed in claim 56, wherein the cleaning brushes are all arranged in a common, vertically oriented plane.

59. The handling device as claimed in claim 53, wherein the cleaning brushes are mounted in an exchangeable manner.

60. The handling device as claimed in claim 56, wherein the cleaning brushes are mounted in an exchangeable manner.

61. The handling device as claimed in claim 41, wherein:
pivotable spike guides are arranged at one of an edge and within the grid field of the suction bells;
the spike guides have fixing spikes which can be extended telescopically in a controlled manner and can be pivoted back and forth in a controlled manner between two end positions determined by adjustable stops; and
in a withdrawing end position, the spike guides are placed flat against the suction gripper and pivoted back behind the suction bell plane; and,
in a working end position, the spike guides are set upright with respect to the suction bell plane, oriented at an inclination to a resin-impregnated mat that is to be picked up.

62. The handling device as claimed in claim 61, wherein in the withdrawing end position, the telescopically extendable fixing spikes protrude with their front end out of the associated spike guide, to the extent of the insertion depth.

63. The handling device as claimed in claim 41, wherein the handling device which manipulates the suction gripper comprises a multiaxially movable industrial robot.

64. The handling device as claimed in claim 41, wherein:
each suction bell is mounted at a free end of a piston rod of a lifting cylinder fastened inflexibly in the suction gripper; and
each suction bell can be raised and lowered independently orthogonally to the suction bell plane.

65. The handling device as claimed in claim 64, wherein each suction bell is mounted at the free end of the piston rod via intermediate element which permits elastic pivoting and is made from one of rubber, a helical spring and an expansion bellows.

66. The handling device as claimed in claim 65, wherein:
the piston rods of the lifting cylinders and the elastic intermediate elements are provided in each case with a hole or fluid line passing axially through them;
the piston rods exit a top side of the cylinder housings in a sealing manner; and
vacuum connections for the suction bells are arranged in each case at upper ends of the piston rods so that the vacuum of the respectively associated suction bell can be fed through the piston rod and the elastic intermediate element.

67. The handling device as claimed in claim 64, wherein:
the piston rods of the lifting cylinders exit a top side of cylinder housings in a sealing manner;
a respective piston rod brake is arranged on a freely accessible part of the piston rods;
the piston rod brake is activatable and is provided with a control connection;
depending on a state of activation, the piston rod brake is fixed on or displaceable in a smooth-running manner axially on the piston rod; and
in interaction with an outer end of the cylinder housing, the piston rod brake axially limits the piston rod stroke.

68. The handling device as claimed in claim 41, wherein
a strip-shaped insertion tool protrudes laterally from the suction gripper; and
the insertion tool is fastened to at least one longitudinal side of the suction gripper.

69. The handling device as claimed in claim 41, wherein the suction gripper is divided into two parts which can be pivoted with respect to each other, about a pivot axis that is being arranged in the suction bell plane.

70. A method for automatically handling resin-impregnated mats of differing shape and size, for production of SMC components, said method comprising:
providing a stack of resin-impregnated mats on a supporting surface;
grasping the resin-impregnated mats on an upper surface of said stock, by applying a vacuum simultaneously at a plurality of points on said upper surface, via a corresponding plurality of suction bells;
lifting the resin-impregnated mats in a substantially sag free state via said vacuum applied at said plurality of points, and conveying said resin-impregnated mats to a mold;
depositing the resin-impregnated mats into said mold; and
mechanically cleaning said suction bells, with rotating brushes; wherein
said suction bells are made of a rigid material, and have a contact end that tapers to a relatively thinner annular edge; and
said grasping step comprises pressing the suction bells into said upper surface of the stack of resin-impregnated mats to form a seal around said contact end, and thereafter establishing said vacuum.
